(19) United States
(12) Patent Application Publication
(10) Pub. No.: US 2002/0076258 A1
(43) Pub. Date: Jun. 20, 2002

(54) Skin disinfectant applicator

(76) Inventors: Cynthia T. Crosby, Salt Lake City, UT (US); Weston F. Harding, Lehi, UT (US); Douglas P. Orr, Sandy, UT (US)

Correspondence Address: RICHARD J. RODRICK, ESQ., BECTON, DICKINSON AND COMPANY, 1 Becton Drive, Franklin Lakes, NJ, 07417, US

(21) Appl. No.: 09/741,584

(22) Filed: Dec. 20, 2000

(51) Int. Cl. B43K 5/00; B43K 5/14; A46B 5/02

(52) U.S. Cl. 401/205; 401/132; 401/6

(57) ABSTRACT

The applicator for an anti-microbial prep solution of this invention includes a generally hollow handle having a closed proximal end and an open distal end, a foam pad attached to the hollow handle over the open distal end, and a flow control valve disposed in the distal portion of the hollow handle proximal of the foam pad to control the flow of anti-microbial prep solution to the foam pad.

### BACKGROUND THE INVENTION

This invention relates to an applicator that can be used by a healthcare professional to apply an anti-microbial solution, such as an alcohol-based solution, to a patient's skin. Such an alcohol-based solution can be used for IV and surgical site preparation and as a general skin disinfectant.

Because microorganisms lie on the skin, standard invasive medical procedures require the patient's skin, where the procedure is to take place, to be disinfected prior to the procedure. This skin preparation is important in order to minimize the risk of infection to the patient.

Alcohol has long been recognized as a fast acting broad-spectrum disinfectant. Alcohol-based solutions have many advantages over soap or water based antiseptic solutions, such as reduced prepping and solution drying time. However, alcohol is flammable and its use and application on a patient must be carefully controlled in order to minimize the fire hazard created when an alcohol disinfecting solution is used. Indeed, in its January 1992 Guidance on Surgical Fires, the ECRI stated that approximately ten surgical patient fires come to its attention per year. Most of these fires ignite on or in the patient and obviously cause considerable injury to the patient. The ECRI estimated that this problem is more severe than the numbers would indicate because it believes that numerous other unreported fires occur. This problem is exacerbated today since today's surgical suites and other patient care facilities include a significant number of electrical equipment that may come in contact with the patient. For example, such electrical equipment includes patient monitoring devices, electrosurgical or electrocautery devices, defibrillators, heated probes, drills, burs, argon beam coagulators, fiberoptic light sources and cables and lasers, which all may be used on and around the patient. In addition, the atmosphere in surgical suites and other patient care facilities is made more combustible because of the common use of oxygen there.

Various types of anti-microbial applicators exist but could be improved. For example, many applicators include a self-contained glass ampoule that contains the anti-microbial solution and which is disposed in a semi-rigid handle. The glass ampoule must be opened and in these applicators some device is used to break the glass ampoule. When this occurs, glass shards can be created which presents a potential safety issue if some of the glass shards escape with the anti-microbial solution from the handle.

In addition, some applicators allow the anti-microbial solution to flow therefrom in large uncontrolled amounts. Other applicators do not have a mechanism to shut off the flow of the anti-microbial solution once the flow starts so that all of the anti-microbial solution must be dispensed from the applicator. Both of these types of applicators are problematic because they may allow excessive amounts of the anti-microbial solution to flow onto the patient where it could pool and create a significant fire hazard if the anti-microbial solution is flammable. In addition, a patient is often covered by a surgical cloth drape after prepping, i.e. the disinfecting procedure, takes place. Where a significant amount of the anti-microbial solution is placed on a patient, the surgical drape can collect the vapors from the anti-microbial solution as the excess anti-microbial solution vaporizes. Again, if the anti-microbial solution is flammable, a potential exists for a severe accident to the patient and the healthcare professionals in the area. Also, this inability to adequately control the flow of anti-microbial solution on and around the patient increases the likelihood that the solution will stain material in the area.

### SUMMARY OF THE INVENTION

It is therefore an object of the invention to provide an applicator for an anti-microbial solution that does not require a self-contained glass ampoule containing the anti-microbial solution to be located in the applicator and broken to release the anti-microbial solution therefrom.

It is another object of the invention to provide an applicator for an anti-microbial solution that controls the amount of the solution that flows from the applicator.

It is yet another object of this invention to provide an applicator for an anti-microbial solution that allows the user to stop the flow of the solution therefrom when desired.

It is still another object of this invention to provide an applicator for an anti-microbial solution that allows the solution to remain in the applicator after some of the solution has been dispensed for subsequent use or disposal.

The applicator for an anti-microbial solution of this invention includes a generally hollow handle having a proximal portion with a closed proximal end and a distal portion with an open distal end. A foam pad is attached to the hollow handle over the open distal end, and a flow control valve is disposed in the distal portion of the hollow handle proximal of the foam pad. The proximal portion of the hollow handle contains the anti-microbial solution without a separate glass ampoule to hold the anti-microbial solution. The flow control valve controls the flow of the anti-microbial solution from the hollow handle to the foam pad and then to the patient. The flow control valve may take many forms. It may be a breakable distal wall formed in the handle that may be broken when pressure is applied to the handle in the area of the wall. It may be a slit valve that is designed so that it remains closed when no pressure is exerted on the hollow handle and that opens when pressure is exerted on the distal surface of the foam pad. It may also be a movable plug located in an opening in a distal wall of the handle that can be dislodged when pressure is exerted on the hollow handle.

### BRIEF DESCRIPTION OF THE DRAWINGS

The preferred embodiments are illustrated in the drawings in which like reference numerals refer to like elements and in which:

FIG. 1 is a perspective view, from the rear, of the applicator of this invention;

FIG. 2 is a side elevation view in cross section of the applicator of this invention with a first embodiment of the flow control valve;

FIG. 3 is a rear elevation view in partial cross section of the applicator of this invention taken along line 3-3 of FIG. 2;

FIG. 4 is an enlarged side elevation view in cross section of the first embodiment of the flow control valve for the applicator of this invention shown in FIG. 2;

FIG. 5 is a side elevation view in cross section of a portion of the applicator of this invention with a variation of the first embodiment of the flow control valve;

FIG. 6 is a rear elevation view in partial cross section of the applicator of this invention taken along line 6-6 of FIG. 5;

FIG. 7 is an enlarged side elevation view in cross section of a variation of the first embodiment of the flow control valve for the applicator of this invention shown in FIG. 5;

FIGS. 8 is a side elevation view in cross section of a portion of the applicator of this invention with a second embodiment of the flow control valve;

FIG. 9 is a rear elevation view in partial cross section of the applicator of this invention taken along line 9-9 of FIG. 8 but with the slit opened;

FIG. 10 is an enlarged side elevation view in cross section of the second embodiment of the flow control valve for the applicator of this invention shown in FIG. 8;

FIG. 11 is a side elevation view in cross section of a portion of the applicator of this invention with a third embodiment of the flow control valve;

FIG. 12 is a rear elevation view in partial cross section of the applicator of this invention taken along line 12-12 of FIG. 11; and

FIG. 13 is an enlarged side elevation view in cross section of the third embodiment of the flow control valve for the applicator of this invention shown in FIG. 11.

### DETAILED DESCRIPTION OF THE INVENTION

As used herein, the term “proximal” refers to a location on the applicator for an anti-microbial solution of this invention that, during normal use, is closest to the clinician using the device and farthest from the patient in connection with whom the device is used. Conversely, the term “distal” refers to a location on the applicator of this invention that, during normal use, is farthest from the clinician using the device and closest to the patient in connection with whom the device is used.

As used herein, the term “top”, “up” or “upwardly” refers to a location on the applicator for an anti-microbial solution of this invention that, during normal use, is radially away from the device and away from the patient's skin. Conversely, as used herein, the term “bottom”, “down” or “downwardly” refers to a location on the applicator of this invention that, during normal use, is radially away from the device and toward the patient's skin.

As used herein, the term “in” or “inwardly” refers to a location with respect to the applicator for an anti-microbial solution of this invention that, during normal use, is toward the inside of the device. Conversely, as used herein, the term “out” or “outwardly” refers to a location with respect to the applicator of this invention that, during normal use, is toward the outside of the device.

Although the applicator of this invention is described for use with an alcohol-based anti-microbial prep solution, it is to be understood that any liquid prep solution may be used with the applicator.

The applicator 10 for an anti-microbial solution of this invention includes a generally hollow handle 20 having a proximal portion with a closed proximal end and a distal portion with an open distal end. A foam pad 30 is attached to hollow handle 20 over the open distal end. A flow control valve 40 is located in the distal portion of hollow handle 20 proximal of foam pad 30. An anti-microbial prep solution is located in the proximal portion of hollow handle 20.

Hollow handle 20 can take any configuration desired and can be formed from any semi-rigid material. Preferably, hollow handle 20 is formed from a transparent or translucent polymer, such as low, medium or high density polyethylene, polyolefin, PET or the like. Since most prep solutions are colored with a dye or naturally are brown, such as iodine, this feature will allow the clinician to easily determine the amount of prep solution remaining in hollow handle 20. Of course, the material used must remain stable in the presence of the various prep solutions that will be contained in hollow handle 20. For example, where alcohol is the active ingredient in the prep solution, it has been found that polyolefin or PET should be used as the material for hollow handle 20 because of the stability of that material when exposed to alcohol. The proximal end of hollow handle 20 is sealed with a plug 21 that may be press fit or screw fit therein. The distal portion of hollow handle 20 preferably includes a necked down portion having a smaller diameter than the proximal portion of hollow handle.

Flow control valve 40 of this invention is preferably located in the necked down portion of hollow handle 20 and controls the flow of the anti-microbial solution from hollow handle 20 to foam pad 30 and then to the patient.

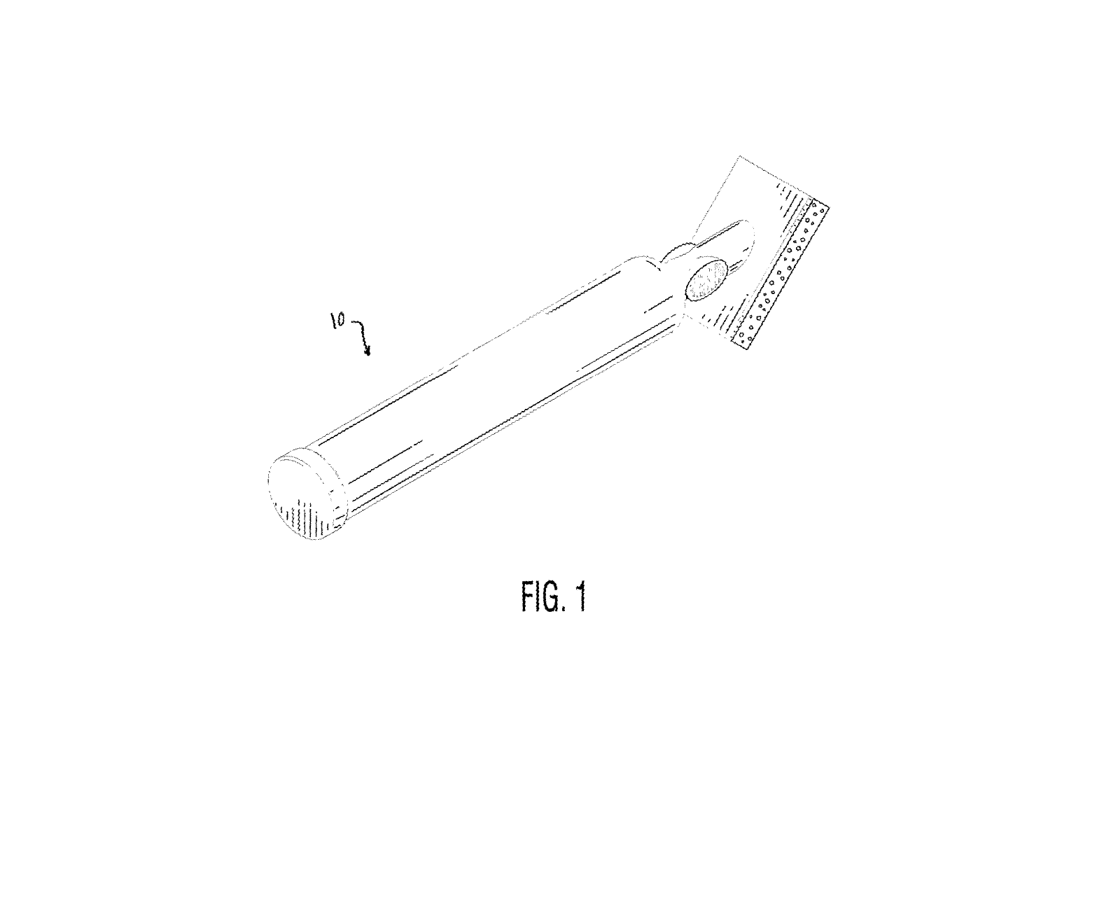

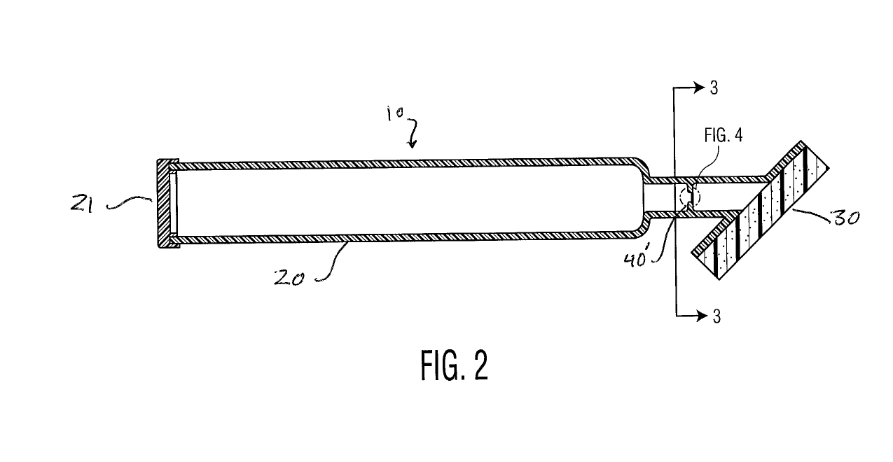

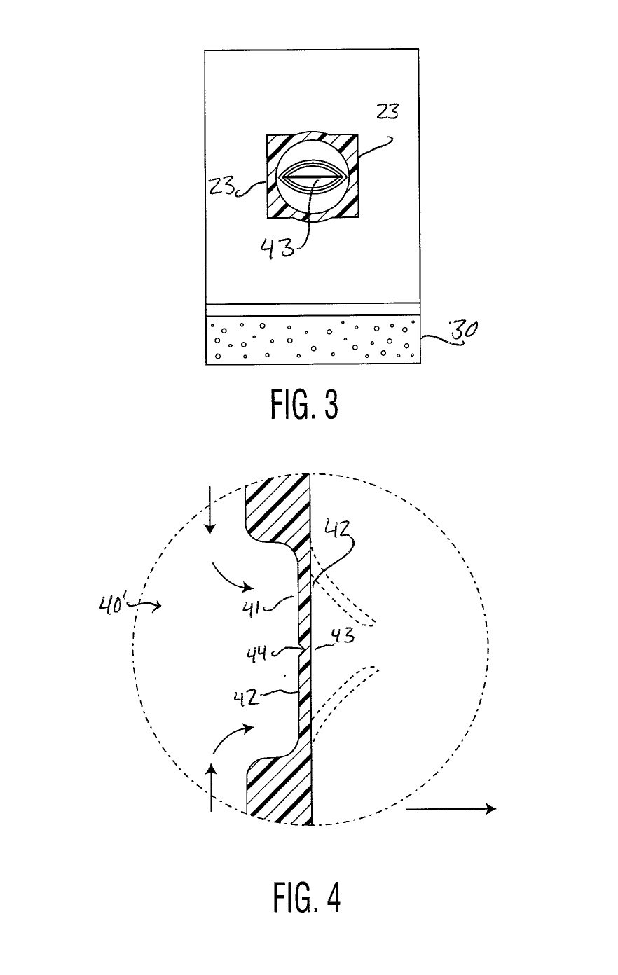

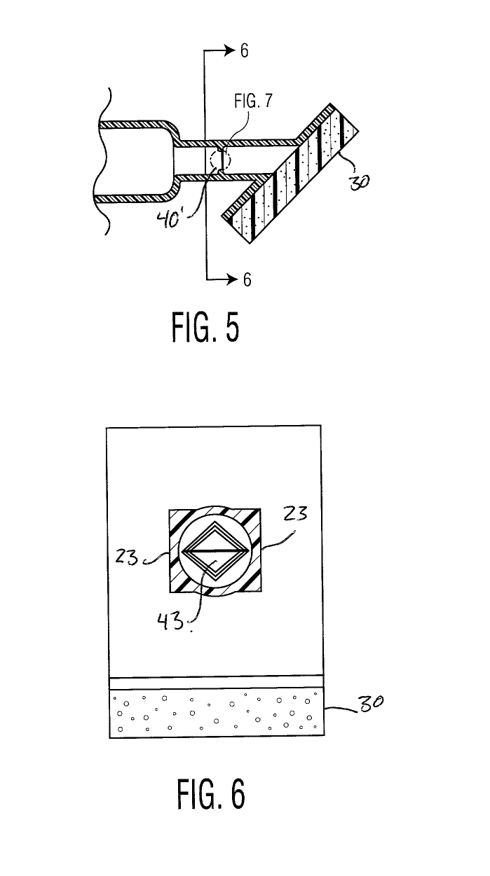

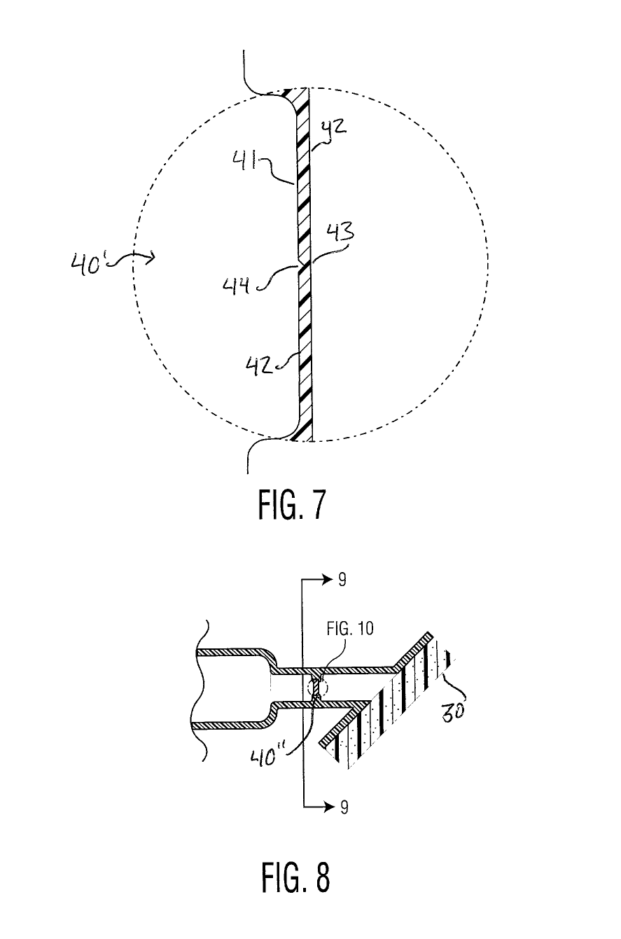

In the first embodiment, see FIGS. 1-7, flow control valve 40′ is a rupturable membrane 41 formed across the lumen of the necked down part of the distal portion of hollow handle 20. Rupturable membrane 41 includes a main portion 42 and a rupturable portion 43 with a diametrical recess 44 formed therein to facilitate rupturing of rupturable portion 43. The necked down part of the distal portion of hollow handle 20 may include one, and preferably two finger grips 23. Preferably, finger grips 23 are located on the exterior of hollow handle 180 degrees apart adjacent to both sides of rupturable membrane 41 and along a line contiguous with the diameter of rupturable membrane 41. When a clinician squeezes finger grips 23, this pressure causes rupturable portion 43 to split initially at recess 44. Thereafter, continued pressure will cause rupturable portion 43 to open and allow the anti-microbial solution contained in the proximal portion of hollow handle 20 to flow into foam pad 30.

Rupturable portion 43 can have any configuration. However, rupturable portion 43 preferably should be in the form of an ellipse as seen in FIG. 3 or a diamond as seen in FIG. 6 with the ends of the ellipse or diamond located by finger grips 23. This arrangement concentrates the pressure on the weakest portion of rupturable portion 43. The wall thickness for main portion 42 should be about 0.006 inches. In addition, the wall thickness at rupturable portion 43 preferably should be about 0.003 inches at its narrowest part. The angle between the tapered portions forming recess 44 should be about 90 degrees.

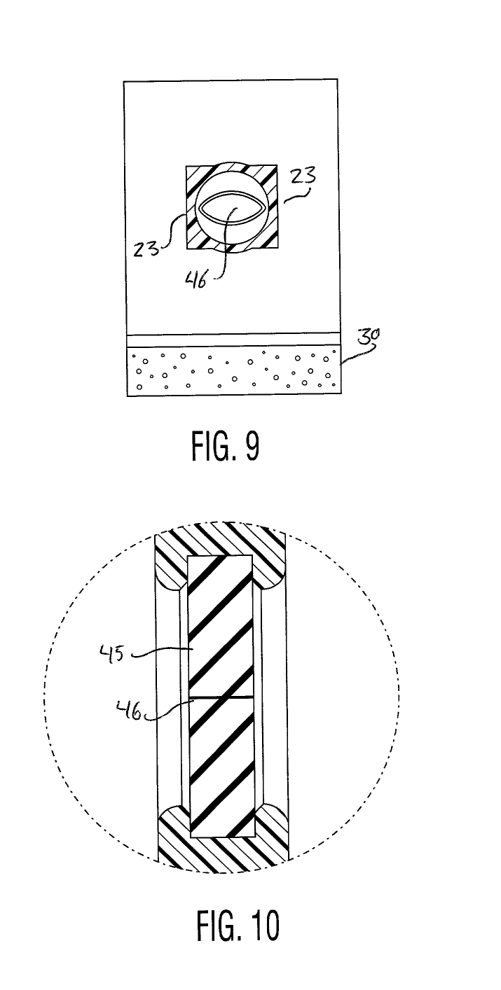

Alternatively, flow control valve 40″ may be an elastomeric membrane 45 having a slit 46 formed therein located across the necked down part of distal portion of hollow handle 20. See FIGS. 8-10. Slit 46 is designed so that it remains closed when no pressure is exerted on it but that opens to allow the anti-microbial prep solution to flow past the slit into foam pad 30 when pressure is exerted on it. Slit 46 can take any form. For example, slit 46 could be curved or undulating or star shaped and a plurality of slits could be used. However, slit 46 is preferably linear and extends entirely through elastomeric membrane 45. Alternatively, slit 46 could initially extend only partially through elastic membrane 45. In addition, slit 46 is preferably aligned with finger grips 23 so that when a clinician squeezes finger grips 23, slit 46 is opened. When the clinician releases pressure from finger grips 23, slit 46 closes preventing any further flow of the anti-microbial prep solution from the proximal portion of hollow handle 20 into foam pad 30. The use of slit 46 thus provides the clinician with greater control over the flow of anti-microbial prep solution from applicator 10.

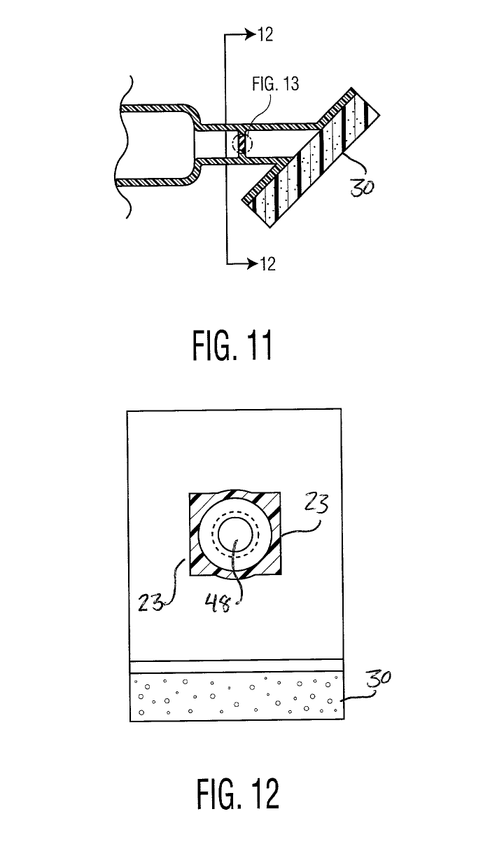

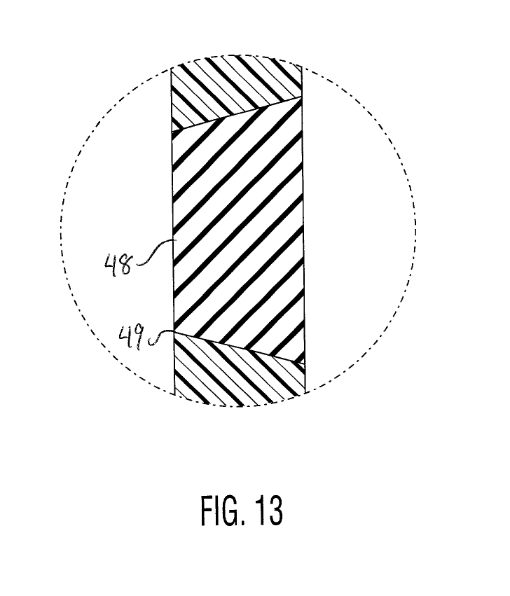

In a third embodiment, flow control valve 40 could take the form of a plug 48 held in an opening 49 formed in a distal wall extending across the necked down part of the distal portion of hollow handle 20. See FIGS. 11-13. When a clinician squeezes finger grips 23, plug 48 is dislodged from opening 49 allowing the anti-microbial prep solution to flow from the proximal portion of hollow handle 20 into foam pad 30. Plug 48 is smaller than the cross section of the necked down part of the distal portion of hollow handle 20 to allow the anti-microbial prep solution to flow past plug 48 to foam pad 30 once plug 48 is dislodged. Preferably, plug 48 has a frusto-conical shape having sides at an angle of about 30 degrees. This configuration facilitates the dislodgement of plug 48 when finger grips 23 are squeezed.

Foam pad 30 is attached to hollow handle 20 over its open distal end by adhesive, flame bonding or any other suitable means. Preferably, the longitudinal axis of foam pad 30 is oriented at about 45 degrees to the longitudinal axis of the distal portion of hollow handle 20. Foam pad 30 must be chemically resistant to the anti-microbial prep solution and is preferably an open cell foam, such as polyurethane or other suitable open cell foam material, that allows the anti-microbial prep solution to pass therethrough. The face of foam pad 30 can have any shape desired. It can have a generally square or rectangular shape, a trapezoidal shape, a shape analogous to home plate in baseball, a circular shape, an elliptical shape or a triangular shape. The foregoing examples are illustrative only and in no way limit the invention.

Thus it is seen that an applicator for an anti-microbial prep solution is provided that does not require a self-contained glass ampoule containing the solution to be located in the applicator which must be broken to release the solution therefrom, that controls the amount of the solution that flows from the applicator, that allows the user to stop the flow of the solution therefrom when desired and that allows the solution to remain in the applicator after some of the solution has been dispensed for subsequent use or disposal.

We claim:

1. An applicator, comprising:
a handle having a closed proximal end and an open distal end wherein a fluid is disposed in the handle;
a foam pad disposed over the open distal end; and
a means disposed in the handle for controlling the flow of the fluid from the handle to the foam pad.

2. An applicator, comprising:
a handle having a closed proximal end and an open distal end wherein a fluid is disposed in the handle;
a foam pad disposed over the open distal end; and
a rupturable membrane disposed in the handle proximal of the foam pad.

3. The applicator of claim 2 further comprising at least one finger grip on the handle adjacent to the rupturable membrane.

4. The applicator of claim 3 wherein the rupturable membrane includes a recess aligned with the finger grip.

5. The applicator of claim 2 wherein the rupturable membrane includes a elliptical face portion.

6. The applicator of claim 5 further comprising at least one finger grip wherein the finger grip is located along a line contiguous with the diameter of the elliptical face portion.

7. The applicator of claim 2 wherein the rupturable membrane includes a diamond-shaped face portion.

8. The applicator of claim 7 further comprising at least one finger grip wherein the finger grip is located along a line contiguous with the diameter of the diamond-shaped face portion.

9. An applicator, comprising:
a handle having a closed proximal end and an open distal end wherein a fluid is disposed in the handle;
a foam pad disposed over the open distal end; and
a slit valve disposed in the handle proximal of the foam pad.

10. The applicator of claim 9 further comprising at least one finger grip on the handle adjacent to the rupturable membrane.

11. The applicator of claim 10 wherein the slit valve includes a slit aligned with the finger grip.

12. An applicator, comprising:
a handle having a closed proximal end and an open distal end wherein a fluid is disposed in the handle;
a foam pad disposed over the open distal end;
a wall disposed in the handle proximal of the foam pad and defining an opening therein; and
a plug removably disposed in the opening.

13. The applicator of claim 12 further comprising at least one finger grip on the handle adjacent to the wall.

14. The applicator of claim 12 wherein the plug has a frusto-conical configuration.
